(19) United States
(12) Patent Application Publication
(10) Pub. No.: US 2015/0159360 A1
(43) Pub. Date: Jun. 11, 2015

(54) SYSTEM AND METHOD FOR MINIMIZING SEDIMENT ACCUMULATION IN POND INLETS

(71) Applicants: Cory ALBERS, Calgary (CA); Bernard AMELL, Calgary (CA)

(72) Inventors: Cory ALBERS, Calgary (CA); Bernard AMELL, Calgary (CA)

(21) Appl. No.: 14/564,975

(22) Filed: Dec. 9, 2014

Related U.S. Application Data
(60) Provisional application No. 61/913,977, filed on Dec. 10, 2013.

(51) Int. Cl. E03F 1/00; B01D 21/00; E02B 15/10; E03F 5/14; E02B 3/02; E02B 8/02

(52) U.S. Cl. CPC E03F 1/00; E02B 3/023; E02B 8/02; E02B 15/10; E03F 5/14; B01D 21/0003

(57) ABSTRACT

Embodiments deliver sediment-containing inflow to a pond through a low flow inlet, or through the low flow inlet and a high flow inlet. A hydraulic control system uses a flow directing element, such as a basin, manhole or the like, to collect the inflow and a spill control element, such as a weir or a high elevation point within a pipe or channel, to determine when the inflow is delivered entirely through the low flow inlet or is split between the low flow inlet and the high flow inlet. Flow through the low flow inlet is maintained at a minimum sediment-mobilizing velocity to ensure sediment is discharged from the inlet to the pond. The inflow is discharged from the low flow inlet and the high flow inlet at different locations in the pond.

### CROSS-REFERENCE TO RELATED APPLICATIONS

This application claims the benefits, under 35 U.S.C 119(e), of U.S. Provisional Application 61/913,977, filed Dec. 10, 2013, the subject matter of which is incorporated herein by reference in its entirety.

### FIELD

Embodiments taught herein are directed to systems and methods for minimizing sediment accumulation in inlets, and, more particularly, in inlets, such as pipes, channels or the like, which feed ponds that accumulate water flows.

### BACKGROUND

It is well known in the field of stormwater and industrial liquid waste management systems to provide ponds to receive contaminated water flows for treatment prior to discharging the treated water into local watersheds or sewers where permitted. Contaminated water is typically delivered to a pond through a network of drainage pipes that receive runoff, such as in manholes, from lands exposed to a precipitation event. Although the water conveyed by drainage pipes contains a number of different contaminants, contaminants in the form of sediment can cause a number of expensive and inconvenient management problems.

One of many possible configurations of a conventional stormwater pond is for an inlet pipe to discharge water below a pond normal water level NWL. This configuration leaves a variable length of the inlet pipe either fully or partially submerged, depending on a water surface elevation WSE in the stormwater pond which may generally be expected to fluctuate between the normal water level NWL and a high water level HWL.

Typically, a stormpond is operated in a lagoon style where the stormpond is maintained at all times as a water body with a contiguous water surface. Less common, but no less a stormpond, are embodiments where divisions in the water body form multiple cells which break up the greater stormpond into discrete functional areas which may create discontinuous water surface areas. The operating normal water level NWL and/or high water level HWL in the one or more cells in a stormpond may be the same or different as may be deemed appropriate by one skilled in the art.

A general relationship between flow in an inlet pipe and time, typically known as a flow hydrograph. Those skilled in the art understand that the general shape of a pipe flow hydrograph, in the context of storrmwater systems, is relatively consistent for both large and small runoff events, however the magnitude of flow at any given time is much greater for large runoff events when compared to small runoff events.

In conventional systems, for relatively low intensity storm runoff events, sediment mobilized by water and conveyed in a network of upstream drainage pipes, reaches the inlet pipe which unintentionally functions as an inline sedimentation basin where normally free flowing water rapidly slows down upon encountering the normal water level NWL inside the inlet pipe.

Particularly in the fully submerged portion of the inlet pipe, relatively coarse sediment settles out in the inlet pipe and generates significant sediment accumulations over time which may eventually block a significant fraction of the cross sectional area of the inlet pipe. A significant blockage of this kind can critically impair the overall system peak flow conveyance performance. Such impairment may cause unintended surcharging of normally freeflowing upstream pipes or other performance problems at lower flows than would normally be the case without any blockage. Sediment that happens to pass through the end of the inlet pipe tends to be deposited in the stormwater pond, but relatively near the inlet pipe. Sediment deposition thicknesses at relatively large distances from the inlet pipe tend to be significantly smaller.

In conventional systems, designed sediment accumulation areas, typically known as sediment forebays, are generally expected to provide an environment suitable for capturing sediment. Applicant believes however relatively rare, but very high flow rates conveyed through the inlet pipe in response to a large storm event, can cause a major sediment mobilization event both for the sediment accumulations in the inlet pipe and for the sediment accumulations relatively near to, but external to the inlet pipe, such as in the forebay. The result is that contrary to how facility designers typically expect the sedimentation forebays to function, the deposited sediment exposed to the relatively rare high intensity inflow event, in fact, acts as a major source of sediment to be mobilized. Such a sediment mobilization event, where a pond or a sedimentation forebay is upstream from a wetland or other sensitive receiving aquatic environment, has the potential to cause a great deal of irreparable damage to the receiving environment.

It is extremely expensive and inconvenient to remove sediment accumulations from a partially blocked inlet pipe or from an area of accumulation in the pond near the inlet pipe as stormwater ponds are not typically designed to facilitate this form of maintenance activity. Executing this maintenance activity may require partial or total pond dewatering to permit access to potentially widespread sediment accumulations in a stormpond and/or to localized sediment accumulations in an inlet pipe. It is understood that the cost of removing sediment from within or relatively near major inlet pipes can be millions of dollars.

Applicant is, at this time, unaware of any practical technologies or strategies for proactively resisting or minimizing sedimentation in inlet pipes without the use of dedicated sediment removal vaults such as Stormceptor® or Downstream Defender® systems. Dedicated sediment removal vaults effectively manage relatively large sediment particles, such as about 75 μm diameter and larger, but are generally incapable of preventing or minimizing the problems identified above from happening for smaller sediment particles, such as about 50 μm, or smaller, in diameter. The smaller sediment particles generally cause problems when mobilized during a relatively rare, large flow event. Dedicated sediment removal vaults are also expensive to build and operate and cannot effectively handle peak flow rates that may be expected to enter a stormpond.

As can be appreciated there is great interest in methods and systems which minimize the accumulation of sediment so as to avoid the high costs of remediation which results therefrom.

### SUMMARY

Embodiments taught herein utilize a hydraulic control system which comprises a flow directing element and a spill control element to deliver a sediment-containing inflow to a receiving pond through a low flow inlet or through the low flow inlet and a high flow inlet. The flow directing element, such as a basin, manhole or the like, collects the inflow. A spill control element, such as a weir or a high elevation point within a pipe or channel, determines when the inflow is delivered entirely through the low flow inlet or is split between the low flow inlet and the high flow inlet. Flow through the low flow inlet is delivered at a minimum sediment-mobilizing velocity to ensure sediment is discharged from the inlet to the pond. The spill control element can be located within or outside of the flow directing element. In embodiments, discharges from the low flow inlet and the high flow inlet are directed to different locations in the pond.

When the rate of flow of the inflow is such that the water surface elevation is below the threshold, the inflow is delivered to the pond through the low flow inlet. When the rate of flow is such that the water surface elevation rises above the threshold, while inflow continues to be delivered to the pond through the low flow inlet, the rising inflow spills over the spill control element to the high flow inlet for delivery of a balance of the inflow to the pond therethrough.

Existing stormwater systems can be retrofit by adding the spill control element, such as a weir, to an existing manhole and reconnecting the existing drainage inlet to act as the high low inlet and adding a new low flow inlet.

Alternatively, a new retrofit manhole can be constructed offset the existing manhole, the retrofit manhole having the spill control weir therein. Again the existing drainage inlet is reconnected to the retrofit manhole to act as the high flow inlet and the new low flow inlet is fluidly connected thereto.

In a broad aspect, a system for directing sediment-containing fluids to a receiving pond comprises at least one low flow inlet for fluidly connecting to the pond and at least one high flow inlet for fluidly connecting to the pond. An hydraulic control system fluidly connects between the low flow inlet and the high flow inlet for delivering the sediment-containing inflow through the at least one low flow inlet for delivery to the pond, at a minimum sediment-mobilizing velocity, when a rate of flow of fluids maintains a water surface elevation at an upstream side of the hydraulic control element at or below a threshold; and when the rate of flow of fluids causes the water surface elevation at the hydraulic control element to rise above the threshold, to deliver a balance of the sediment-containing inflow through the at least one high flow inlet for delivery to the pond.

In another broad aspect, a method for directing sediment-containing fluids to a receiving pond comprises fluidly connecting at least one low flow inlet and at least one high flow inlet to the pond. An hydraulic control system is fluidly connected between the low flow inlet and the high flow inlet for delivering the sediment-containing inflow through the at least one low flow inlet for delivery to the pond, at a minimum sediment-mobilizing velocity, when a rate of flow of fluids maintains a water surface elevation at an upstream side of the hydraulic control system at or below a threshold. The hydraulic control system also delivering a balance of the sediment-containing inflow through the at least one high flow inlet for delivery to the pond when the rate of flow of fluids causes the water surface elevation at the hydraulic control system to rise above the threshold.

In another broad aspect, a method for retrofitting an existing system for directing sediment-containing fluids to a receiving pond having an existing manhole and an existing drainage inlet fluidly connected thereto, comprises positioning a weir wall in the existing manhole therein for dividing the retrofit manhole into an upstream side and a downstream side and having a height for establishing a threshold. The existing drainage inlet is fluidly connected to the upstream side for delivery of sediment-containing inflow thereto. A low flow inlet is fluidly connected to the upstream side for delivery to the pond at a minimum sediment-mobilizing velocity, when a rate of flow of fluids maintains a water surface elevation in the upstream side of the retrofit manhole at or below the threshold. The existing drainage inlet is fluidly connected to the downstream side for delivering a balance of the sediment-containing inflow through the at least one high flow inlet for delivery to the pond when the rate of flow of fluids causes the water surface elevation at the hydraulic control element to rise above the threshold.

In yet another broad aspect, a method for retrofitting an existing system for directing sediment-containing fluids to a receiving pond having an existing manhole and an existing drainage inlet fluidly connected thereto comprises positioning a retrofit manhole offset from the existing manhole, the retrofit manhole having a weir wall therein for dividing the retrofit manhole into an upstream side and a downstream side and having a height for establishing a threshold. The existing drainage inlet to the upstream side for delivery of sediment-containing inflow thereto. A low flow inlet is fluidly connected to the upstream side for delivery to the pond, at a minimum sediment-mobilizing velocity. when a rate of flow of fluids maintains a water surface elevation in the upstream side of the retrofit manhole at or below the threshold. The existing drainage inlet is also fluidly connected to the downstream side for delivering a balance of the sediment-containing inflow through the at least one high flow inlet for delivery to the pond when the rate of flow of fluids causes the water surface elevation at the hydraulic control element to rise above the threshold.

### BRIEF DESCRIPTION OF THE DRAWINGS

FIG. 1A is a cross-sectional view of a prior art stormpond illustrating a manhole and an inlet pipe extending therefrom to discharge below the normal water level of the stormpond;

FIG. 1B is a plan view according to FIG. 1A;

FIG. 2 is a flow hydrograph illustrating flow over time, such as during a stormwater event;

FIG. 3A is a cross-sectional view of the prior art stormpond of FIG. 1A illustrating sediment accumulation in the inlet pipe and the stormpond for relatively low intensity storm runoff events;

FIG. 3B is a plan view according to FIG. 3A;

FIG. 4A is a cross-sectional view according to an embodiment disclosed herein having a hydraulic control system comprising a flow directing basin, having a spill control weir therein, positioned upstream of the pond, a low flow inlet delivering inflow from an upstream side of the weir to the pond below a threshold of the weir and a balance of the inflow from a downstream side of the weir when the water surface elevation in the upstream side rises above the weir;

FIG. 4B is a plan view according to FIG. 4A;

FIG. 4C is a cross-sectional view according to FIG. 4A wherein the hydraulic control system comprises a flow directing manhole having a spill control weir wall formed therein;

FIG. 4D is a plan view according to FIG. 4C;

FIG. 4E is a cross-sectional view wherein the hydraulic control system comprises a flow directing Y-connection, the Y-connection receiving the sediment-containing inflow and splitting the inflow to a low flow inlet and a high flow inlet, the high flow inlet having a high elevation point intermediate therein acting as the spill control element;

FIG. 4F is a plan view according to FIG. 4E;

FIG. 5 is a flow hydrograph illustrating a split in flow between the low flow inlet and the high flow inlet, such as during a stormwater event;

FIG. 6A is a cross-sectional view according to FIG. 4C illustrating sediment deposition in the storm pond;

FIG. 6B is a plan view according to FIG. 6A;

FIG. 7A is a cross-sectional view of an embodiment wherein the high flow inlet has a high elevation point intermediate therein acting as the spill control element and the flow directing manhole is absent a weir;

FIG. 7B is a plan view according to FIG. 7A;

FIG. 8A is a cross-sectional view of an embodiment wherein the high flow inlet is an open channel extending from the manhole to the stormpond;

FIG. 8B is a plan view according to FIG. 8A;

FIG. 9A is a cross-sectional view of a retrofit of an existing system wherein a retrofit manhole and low flow inlet, according to an embodiment, are installed offset from an existing manhole and an existing drainage inlet of the existing prior art manhole becomes the high flow inlet;

FIG. 9B is a plan view according to FIG. 9A;

FIG. 10A is a cross-sectional view of a retrofit of an existing system wherein a retrofit manhole according to an embodiment is installed offset from an existing manhole, the existing drainage inlet becoming the high flow inlet pipe and wherein a low flow inlet is installed within the high flow inlet;

FIG. 10B is a plan view according to FIG. 10A; and

FIG. 11 is a plan view of an embodiment disclosed herein in use in a stormpond, the low flow inlet discharging to a first cell or forebay configured as a Nautilus Pond™ and the high flow inlet pipe discharging to a second cell in the stormpond.

### DETAILED DESCRIPTION

Embodiments described herein are generally described in the context of stormwater ponds capable of handling both normal, frequent, low intensity stormwater runoff events and rarer, high intensity, stormwater runoff events, inflows therein carrying sediment. As one of skill will appreciate, the embodiments are also applicable to inflows of other fluids containing sediment which may vary between a low intensity flow and a high intensity flow.

Those skilled in the art would understand that the term “inlet pipe” is understood, from the perspective of a designer of a receiving water body such as a municipal stormwater pond, where flow through a pipe represents an inflow to the receiving water body in question. Alternatively, those skilled in the art may also refer to an inlet pipe as an “outfall pipe” when referenced from the perspective of a designer of a stormwater collection and conveyance system, where flow through the inlet pipe in question represents an outflow from the stormwater collection and conveyance system in question. Embodiments disclosed herein are generally directed to stormwater pond systems and thus, the term “inlet pipe” is used herein. However, the term “outfall pipe” or any other term considered reasonable to those skilled in the art may be substituted, where it is contextually more appropriate, in embodiments not explicitly described herein but which are within the scope of the concepts disclosed herein.

For convenience, the terms “stormwater pond”, “storm pond”, or “pond” are used interchangeably herein and should not be construed as limiting the generality of a receiving water body or environment. Where contextually more appropriate, the receiving water body or environment may be a river, lake, ocean or any other suitable receiving body of water.

As one of skill will appreciate, where the environment is an industrial or mining facility, the inflow may be industrial wastewater, effluent, mine tailings flow or other inflow wherein sedimentation presents similar problems to those described herein in the context of stormwater runoff. Thus while described herein in the context of stormwater runoff, terms such as “stormwater”, “runoff” and the like should be interpreted broadly to cover such other environments.

Pipes herein are explicitly described or implied to have round cross sections however as one of skill in the art would understand the term “pipe” is not intended to be limited to round cross-sections and therefore does not exclude other pipe shapes where deemed appropriate. Further, explicit or implicit references to pipes made of concrete is not intended to limit the material from which the pipe may be constructed where deemed appropriate by those skilled in the art.

As one of skill in the art would understand, a stormpond has an infinite variety of forms that are dictated by combinations of factors. Such factors include, but are not limited to, those related to upstream catchment area size and characteristics, available lands, constructability, cost, operating and maintenance considerations and an almost limitless set of other considerations, as one of skill in the art would understand to be encompassed herein.

Typically, a stormpond is operated in a lagoon style where the stormpond is maintained at all times as a single cell water body with a contiguous water surface. Less common, but no less a stormpond, are embodiments where divisions in the water body form multiple cells which break up the greater stormpond area into discrete functional areas, which may create discontinuous water surface areas. The operating normal water level NWL and/or high water level HWL, in the one or more cells in a stormpond, may be the same or different normal water level NWL and/or high water level HWL as may be deemed appropriate by one skilled in the art.

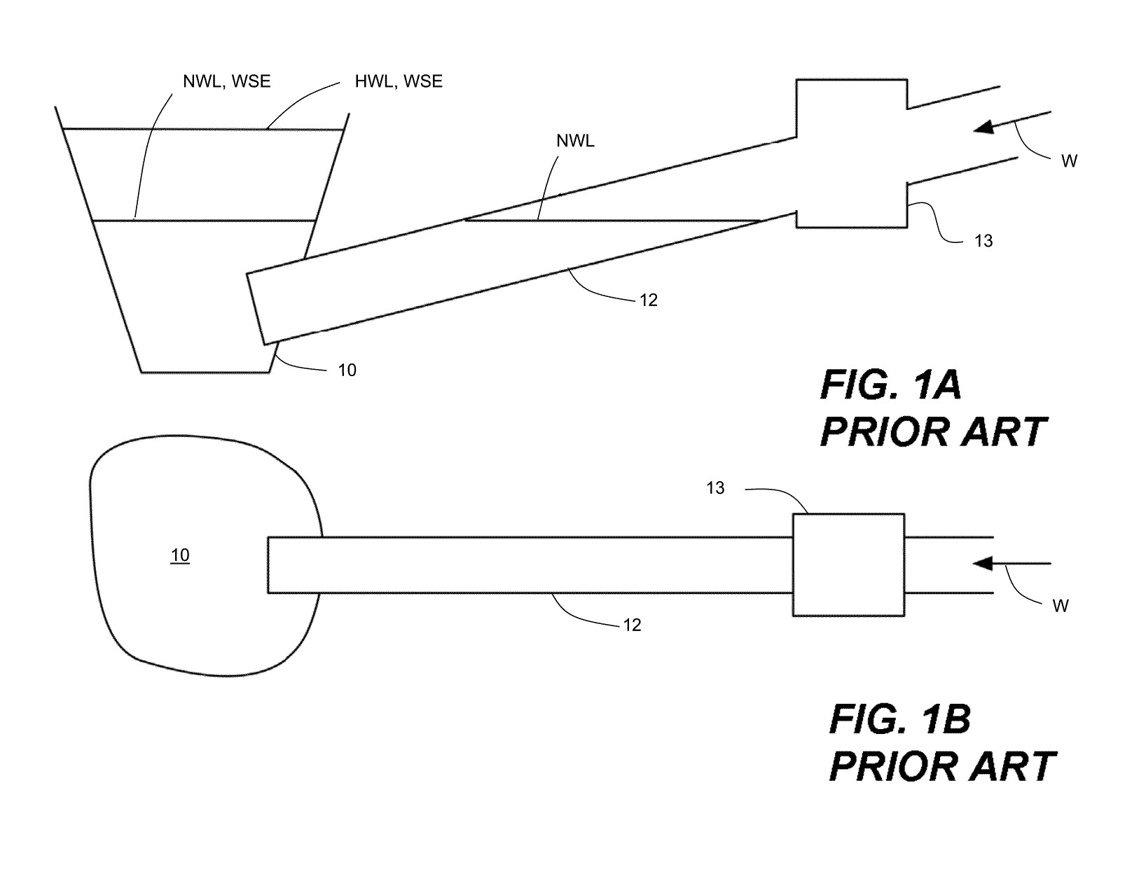

As noted in the background, and as shown in FIGS. 1A and 1B, one of many possible configurations of a conventional stormwater pond 10 is for a drainage inlet 12, typically a stormpipe, to discharge sediment-containing fluid W, being stormwater runoff, below a pond normal water level (NWL). This configuration leaves a variable length of the drainage inlet 12, either fully or partially submerged, depending on a water surface elevation (WSE) in the stormwater pond 10 which may generally be expected to fluctuate between the normal water level NWL and a high water level (HWL). As one of skill will appreciate, drainage inlets 12 are generally vastly oversized for the relatively common, low intensity, stormwater runoff events, so as to be able to handle the rarer, larger intensity stormwater runoff events and are prone to sediment deposition therein as a result of loss of velocity of the fluids W flowing therein. Further, as illustrated, the drainage inlet 12 typically discharges to a manhole 13, positioned intermediate therein and discharges from the manhole 13 to the remainder of drainage inlet 12 downstream thereof for delivery to the pond 10

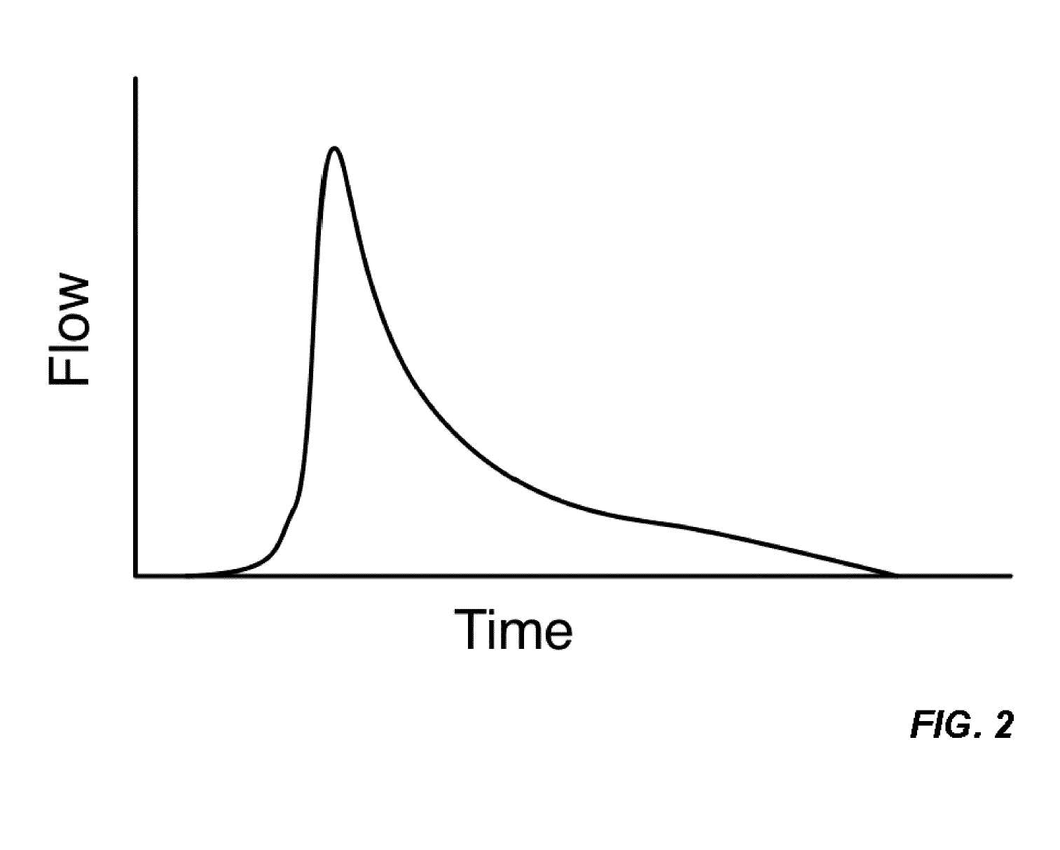

FIG. 2 illustrates a general relationship between flow of runoff water or inflow W in the drainage inlet 12 and time, typically known as a flow hydrograph. Those skilled in the art understand that the general shape of a pipe flow hydrograph, in the context of stormwater systems, is relatively consistent for both large and small runoff events, however the magnitude of flow at any given time is much greater for large runoff events when compared to small runoff events.

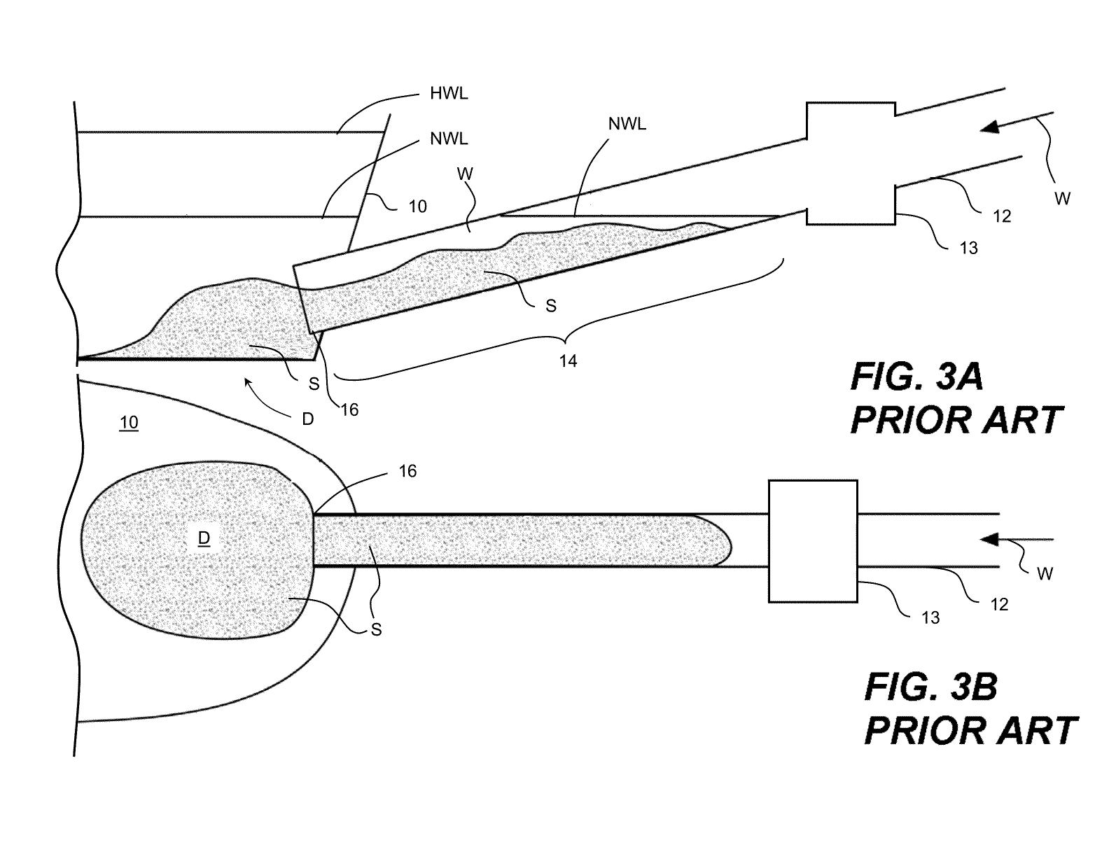

In conventional prior art systems, for relatively low intensity storm runoff events, such as shown in FIGS. 3A and 3B, sediment S, mobilized by runoff water forming a sediment-containing fluid, termed herein for ease of reference as an inflow W, and conveyed in a network of upstream drainage pipes (not shown), reaches the drainage inlet 12. The drainage inlet 12 unintentionally functions as an inline sedimentation basin at a location where normally free flowing inflow W rapidly slows down upon encountering the normal water level NWL inside the drainage inlet 12, resulting from the normal water level NWL in the pond 10.

Particularly in the fully submerged portion 14 of the drainage inlet 12, best seen in FIG. 3A, relatively coarse sediment S settles out within the drainage inlet 12 and generates significant sediment S accumulations over time. Such accumulations may eventually block a significant fraction of a cross-sectional area of the drainage inlet 12. A significant blockage of this kind can critically impair the overall system's peak flow conveyance performance. Such impairment may cause unintended surcharging of normally freeflowing upstream pipes or other performance problems at lower flows than would normally be the case without any blockage. Sediment S that happens to pass through a pond end 16 of the drainage inlet 12 tends to be deposited D in the stormwater pond, relatively near the drainage inlet 12. Sediment deposition D thicknesses at relatively large distances from the drainage inlet 12 tend to be significantly smaller.

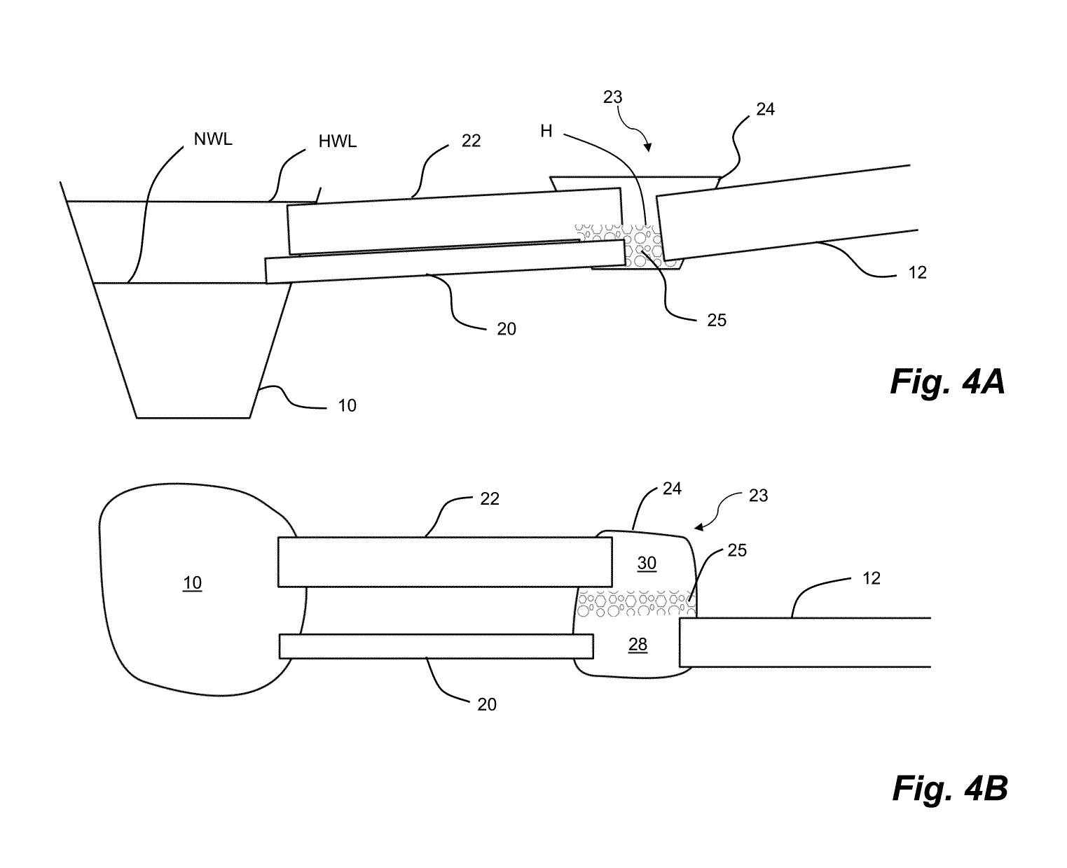

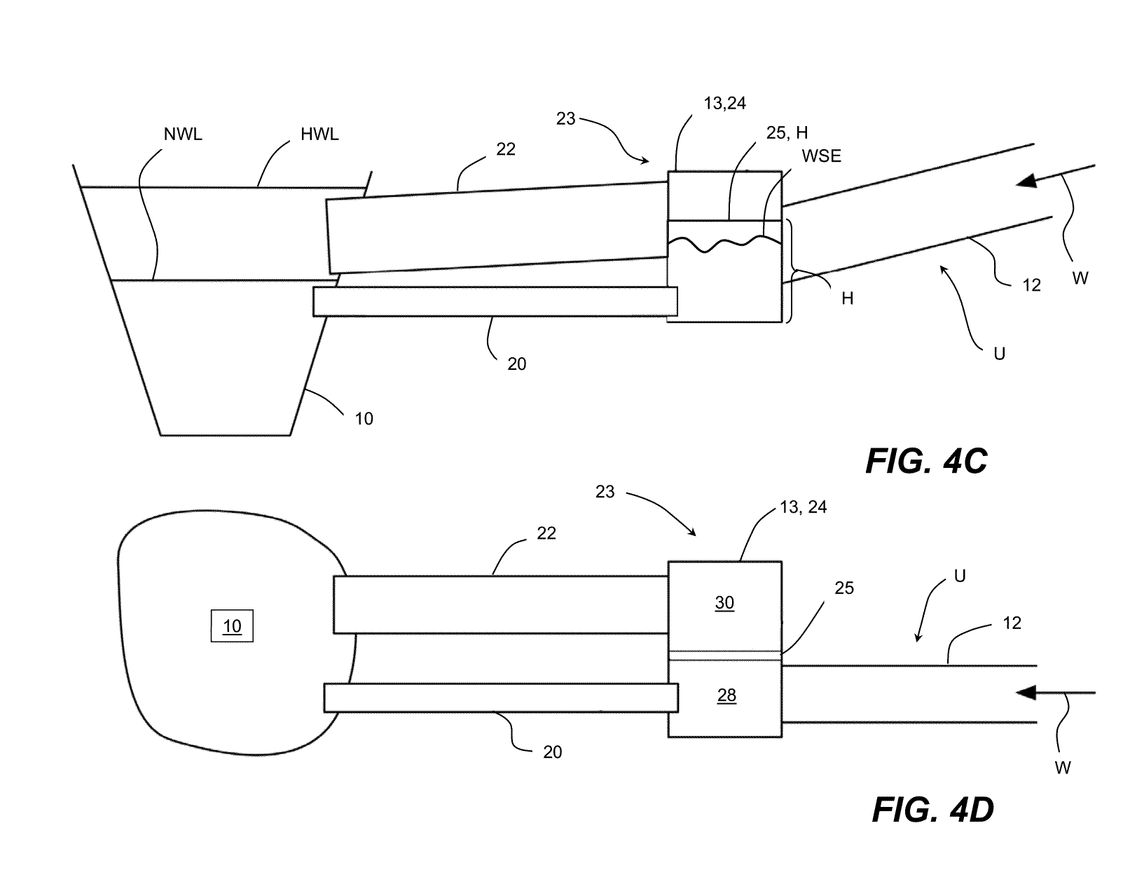

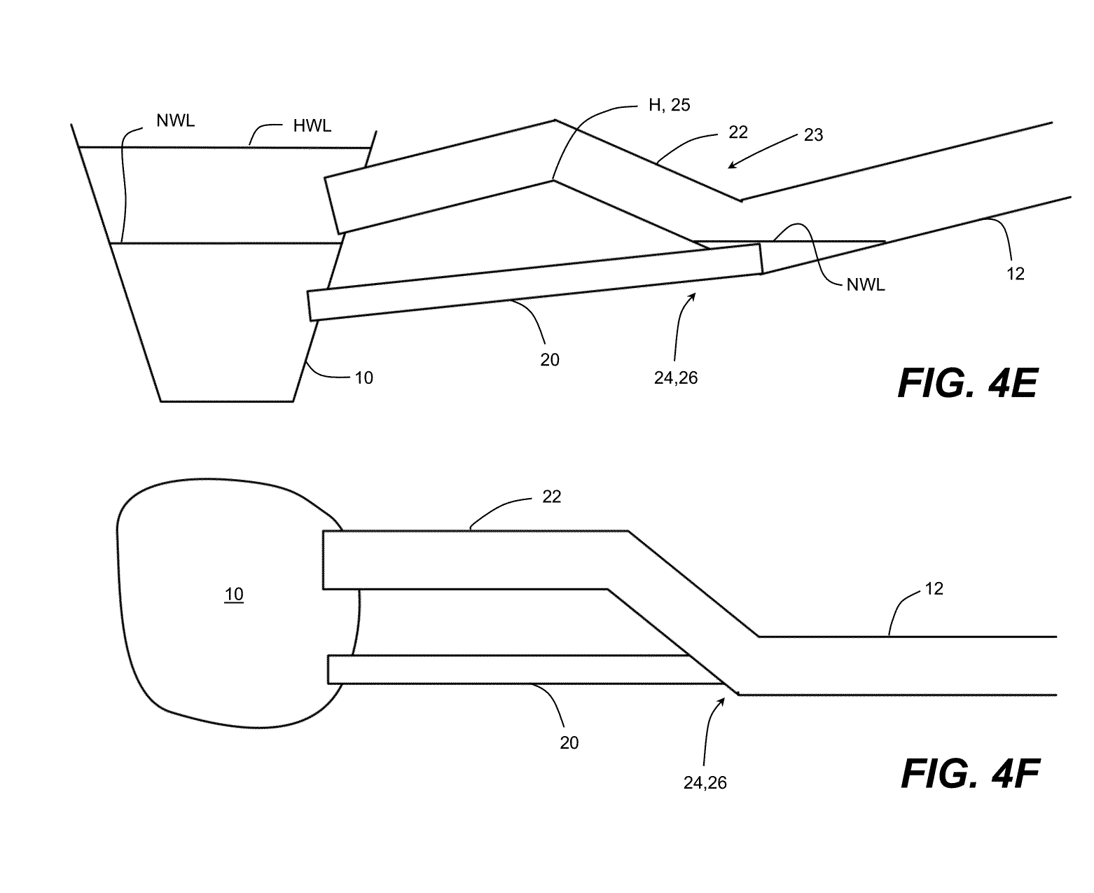

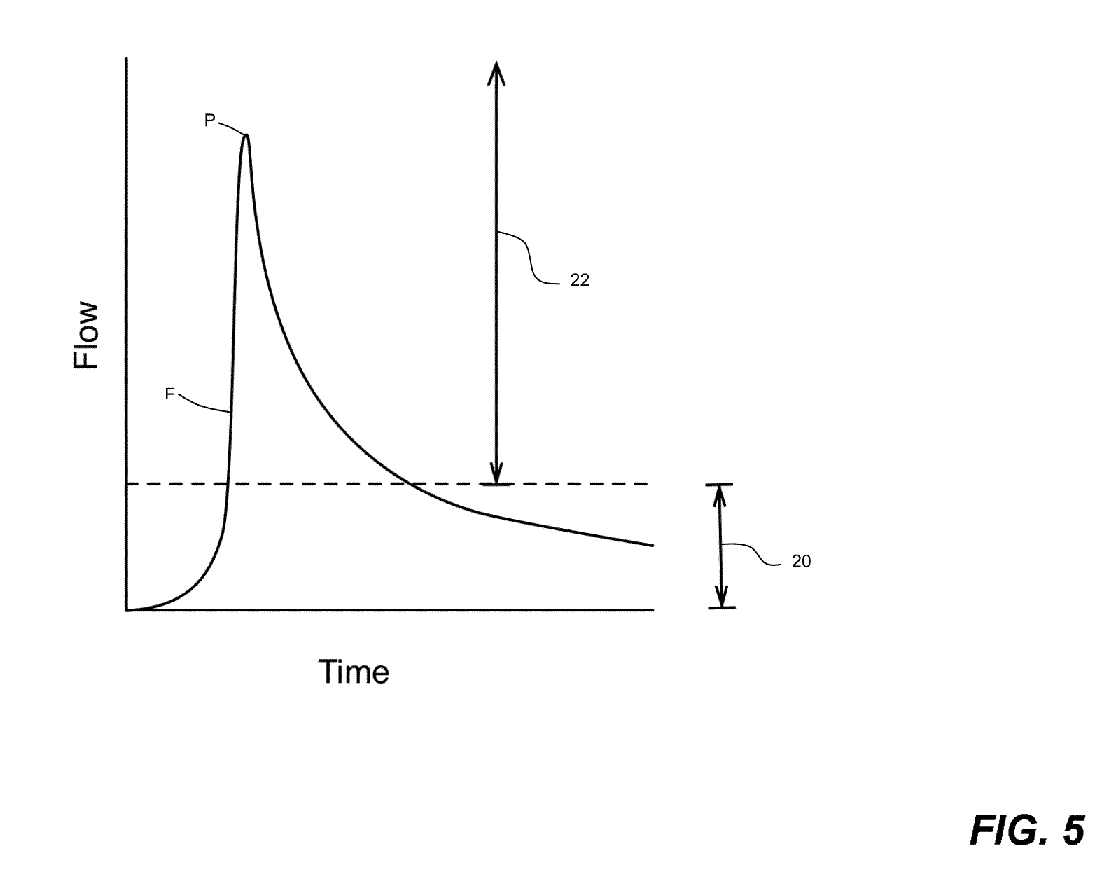

Having reference to FIGS. 4A to 4F, embodiments disclosed herein create a structured environment having a low flow inlet 20 and a high flow inlet 22 and a hydraulic control system 23, comprising a flow directing element 24 which collects the inflow W and a spill control element 25 which establishes a threshold H for delivering inflow to the pond 10 exclusively through the low flow inlet 20 when the volume and flow rates are below the threshold H, such as at the start of a stormwater event or throughout a normally low intensity storm event. Under higher intensity conditions however, when the rate and volume of inflow W causes the water surface elevation WSE to rise above the threshold H of the spill control element 25, the flow directing element 24 continues to deliver inflow W to the pond through the low flow inlet 20 while a balance of the inflow W spills thereover to the high flow inlet 22 for delivery to the pond 10 therethrough.

Having reference to FIGS. 4A and 4B, the spill control element 25 comprises a dividing wall or weir formed in the flow directing element 24, being a basin or other collection body, upstream of the pond 10. The weir 25 divides the upstream basin 24 into an upstream side 28 which receives the inflow W from the drainage inlet 12 and which is fluidly connected to the low flow inlet 20 and a downstream side 30 which is fluidly connected to the high flow inlet 22. A height of the weir 25 determines the threshold H over which the balance of the inflow W will overflow from the upstream side 28 to the downstream side 30 for delivery through the high flow inlet 22 to the pond 10.

Having reference to FIGS. 4C and 4D and best seen in FIG. 4D, in another embodiment, the flow directing element 24 is the manhole 13. The spill control element is a weir wall 25 positioned within the manhole 13, which divides the manhole 13 into the upstream side 28, for receiving the inflow W from the drainage inlet 12 and which is fluidly connected to the low flow inlet 20 and the downstream side 30, fluidly connected to the high flow inlet 22. The manhole's weir wall 25 enables the inflow W to the upstream side 28 below the threshold value H defined by the height of the weir wall 25, to be directed exclusively to the low flow inlet 20. The low flow inlet 20 delivers the inflow W below the threshold H to the pond 10, at or below the normal water level NWL. Once the inflow rate causes the water surface elevation WSE in the upstream side 28 of the manhole 13 to rise above the threshold H, as is typically the case for only very brief durations in response to the relatively common short stormwater runoff events, or for extended durations in response to larger and/or longer high intensity events, the balance of the inflow W entering the upstream side 28 of the manhole 13 spills over the weir wall 25 to the downstream side 30 of the manhole 13. The balance of the inflow W is then directed therefrom to the high flow inlet 22 for delivery to the pond 10.

Further, having reference to FIGS. 4E and 4F, embodiments are contemplated that have hydraulic control systems 23 that do not involve the use of a flow directing basin or manhole. In such cases, the flow directing element 24 is a custom or standard ‘Y’ connection 26, fluidly connected to the high flow inlet 22 and the low flow inlet 20. The spill control element 25 for splitting the inflow W between the high flow inlet 22 and the low flow inlet 20 is a geometry such as a high elevation point H within the high flow inlet 22 for establishing the threshold H at which the inflow W spills over the high elevation point H for delivery to the pond 10.

As one of skill will appreciate any other means can be used that provides a similarly functioning split of the inflow W and a threshold H for controlling the balance of the inflow W that is delivered to the high flow inlet 22.

Managing flows to a target destination is well known, such as in retrofitting an existing environment, generally serviced by a conventional stormwater trunk, with a new stormpond where typically only a small portion of the peak flow conveyed through a major and existing stormwater trunk could be practically received by the new stormpond. Such prior art scenarios typically result in providing one prior art inlet or pipe to discharge into the stormpond with a second prior art inlet or pipe, serving as a high flow bypass, to discharge to a completely different receiving environment, thereby bypassing the stormpond.

Embodiments described herein are specifically focused on problems where all of the runoff water inflow W entering an upstream side U, typically the drainage inlet 12, is expected to be discharged entirely to a receiving environment 10, such as the stormpond. The high flow inlet 22 and the low flow inlet 20 may discharge to the same cell or to different cells of the stormpond 10, as may be deemed appropriate by one skilled in the art.

FIG. 5 illustrates how the inflow hydrograph may be split between the low flow inlet 20 and the high flow inlet 22 using embodiments as taught herein. As one of skill will appreciate, when there are no storm events or runoff, no inflow W is received by the system. As a low intensity storm event begins, the flow rate may initially be too low to mobilize sediment and thus, the initial inflow W may have no sediment entrained therein. As the flow rate begins to increase however, sediment-containing inflow W begins to be delivered to the drainage inlet 12.

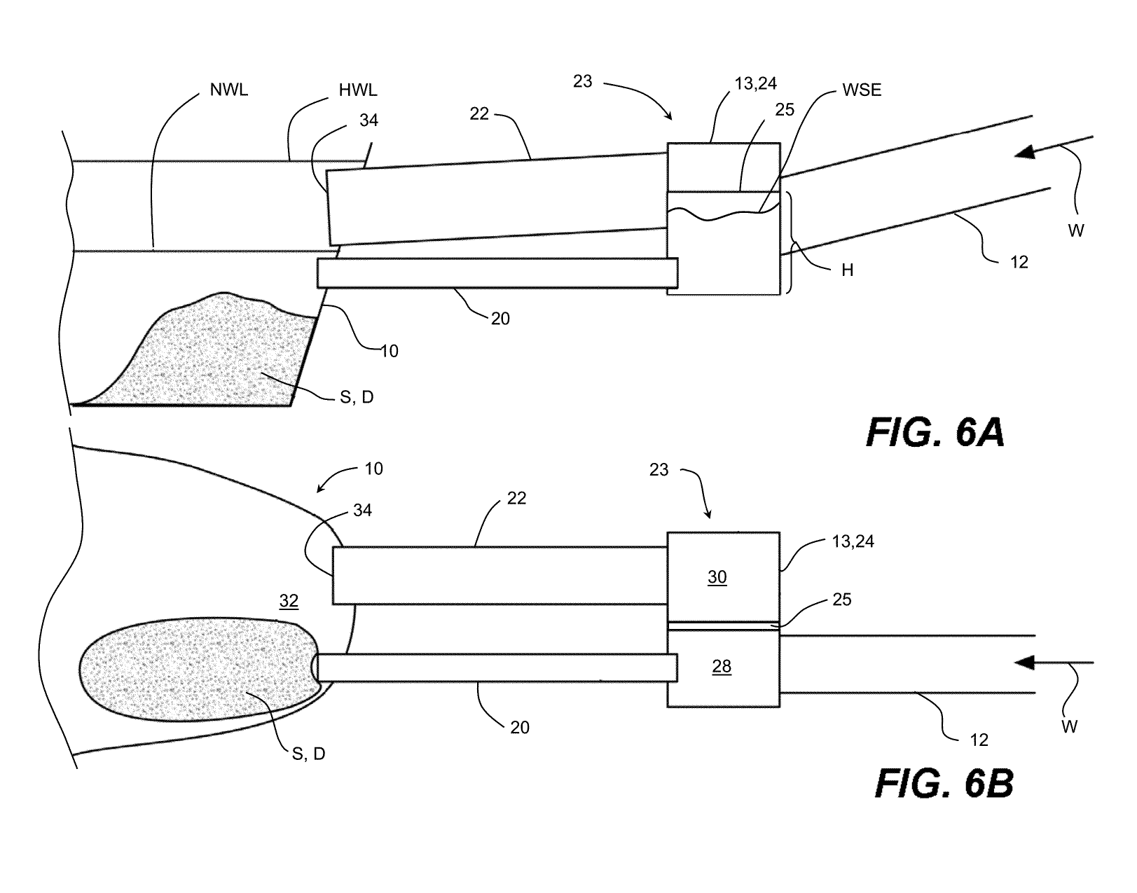

Having reference to FIGS. 6A and 6B, embodiments taught herein discourage significant sedimentation within the low and high flow inlets 20,22. The threshold or crest elevation H of the weir wall 25 is set such that, in response to frequent and relatively low intensity storm events, the water surface elevation WSE on the upstream side 28 is sufficiently high, relative to the pond normal water level NWL to induce a minimum threshold flow in the low flow inlet 20 resulting in an associated minimum sediment-mobilizing flow velocity which is sufficient to discharge the sediment S from the low flow inlet 20 into the pond 10.

It will be appreciated that in order to maintain the minimum sediment-mobilizing flow velocity, a cross-sectional area of the low flow pipe 20 is designed to have a cross-sectional area, largely based upon historical events, capable under typical flow rates to provide sufficient minimum velocity to mobilize the sediment S from the low flow pipe 20 to the pond 10. Further, it will be appreciated that a cross-sectional area of the high flow inlet 22 is such that it can readily handle the balance of the inflow W under the less frequent, high intensity events. By way of example, Applicant believes a suitable ratio of the cross-sectional area of the high flow inlet 22 compared to the low flow inlet 20, to handle both the common low intensity and less frequent high intensity storm water events in Calgary, Alberta, Canada is about 10:1, the low flow inlet being about 400-450 mm in diameter and the high flow inlet 22 being about 1200 mm in diameter. The diameter of the low flow inlet 20 is designed to maintain the minimum sediment-mobilizing velocity during at least the low intensity events.

As one of skill will appreciate, where embodiments are utilized for inflows other than stormwater, such as tailings from mining or wastewater from sewage treatment or the like, the hydrograph may be significantly different in shape than that seen in FIG. 5. For example, because such processes may continually produce a relatively fixed volume of inflow under normal operations, the rate of flow is sufficient to support the minimum sediment-mobilizing velocity in a low flow inlet 20 of the same or larger size than the high flow inlet 22.

Also as shown in FIG. 6B, the low flow inlet 20 beneficially discharges to a location entirely separate from that of the high flow inlet 22. Such discharge separation is beneficial because the environment to which the low flow inlet 20 discharges, such as a sedimentation forebay 32, is the area intended for primary sediment removal from the inflowing water W. It is of enormous benefit as it minimizes the peak flow rate entering the sedimentation forebay 32, thus preventing re-suspension of previously deposited sediment and enabling the sedimentation forebay 32 to appropriately create a quiescent environment with sufficient retention time for removing sediment particles S that require time to settle out of suspension.

It is well known that a majority of sediment S conveyed through a stormwater collection network is generated in response to the relatively frequent and low intensity storm events which pass most, if not all, flow through the low flow inlet 20 described herein.

For rarer, larger intensity storm events that deliver significant flow volumes through the high flow inlet 22, a first flush F of water in the very early part of the hydrograph (FIG. 5), typically prior to a peak flow rate P, delivers a disproportionately large fraction of the sediment S, mobilized from a catchment area to the stormpond 10. As a result, and in general, embodiments such as shown in FIGS. 6A and 6B deliver most of the sediment-carrying inflow W, generated by the catchment area, through the low flow inlet 20. Thus, the high flow inlet 22 delivers only a small fraction of the total sediment S load generated by a catchment area to the target, receiving stormpond 10 and will therefore be unlikely to cause significant sediment accumulations inside the high flow inlet 22 or in the pond 10 at, or near, a discharge end 34 of the high flow inlet 22.

Having reference to FIGS. 4C and 6A, the low flow inlet 20 is shown having no slope at all. This is simply because flow in a submerged pipe is caused not by the overall slope of the pipe bottom, but instead is caused by the overall slope of the energy grade line (EGL) between the manhole 13 through which the inflow W passes and the stormpond 10 which ultimately receives the inflow W. As a result, when there is no inflow W entering the stormpond 10, the water surface elevation WSE in the manhole 13 is coincidental with the water surface elevation WSE in the stormpond 10. It is expected that the water surface elevation WSE on the upstream side 28 of the weir wall 25, even in response to frequent and low intensity storm events, will be high enough relative to the stormpond normal water level NWL to induce a minimum sediment mobilization flow velocity in the low flow inlet 20. Thus, the low flow inlet slope can be positive (i.e., the bottom of the pipe is higher at the manhole than at the end discharging to the pond), zero (i.e., the bottom of the pipe is the same everywhere) or even negative (i.e., the bottom of the pipe is higher at the end discharging to the pond than it is at the manhole) or any combination of slopes. It is well known to those skilled in the art that constructing a low flow inlet 20 with little or no slope at all (FIG. 4C) could result in substantial construction simplification and cost savings as the low flow inlet 20, if a pipe, would likely not need to be buried as deeply as would a low flow inlet 20 with a greater slope.

Although the low flow inlet 20 of FIGS. 4C and 6A is shown as being fully submerged at the pond's normal water level NWL throughout its entire length, embodiments could include a partially submerged or an unsubmerged low flow inlet 20 or combination thereof. FIGS. 4C and 6A also illustrate the high flow inlet 22 as being entirely unsubmerged however embodiments wherein the high flow inlet 22 is partially submerged, completely submerged or combinations thereof are also possible. While discussed herein as having only one low flow inlet and one high flow inlet 20,22, embodiments are contemplated utilizing more than one low flow inlet 20 and more than one high flow inlet 22 where deemed appropriate by one skilled in the art.

Where the low flow inlet 20 is unsubmerged or partially submerged, embodiments disclosed herein can be used to reduce the minimum required bottom slope of the low flow inlet 20. As discussed above with reference to a submerged low flow inlet 20 with no bottom slope, this is because the concepts contemplated herein can be expected to create an energy grade line EGL in a low flow inlet 20 that is capable of creating the minimum sediment mobilizing velocity in a manner that is generally independent from the low flow inlet bottom slope.

Although embodiments implemented in stormwater management systems typically are expected to operate passively and without any operator intervention, embodiments capable of effecting the intended system control strategy that include active operator or automated management (i.e., through the use of pumps, valves, gates or other similarly capable means) are also possible.

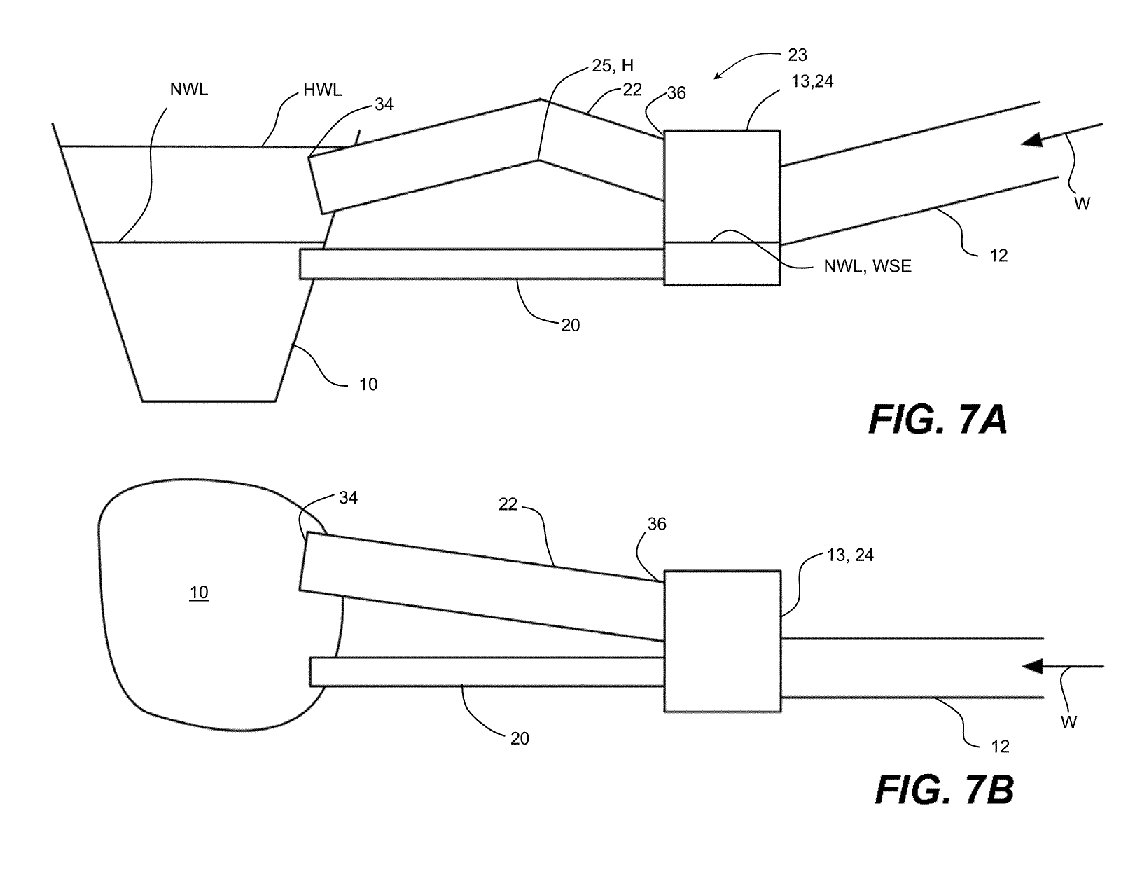

Having reference to FIGS. 7A and 7B, an embodiment is illustrated in which the manhole 13 is absent the weir wall 25. In this embodiment, the spill control element 25, which controls when a portion of the inflow W is diverted to the high flow inlet 22, is a geometry of the high flow inlet 22. The geometry 25 comprises a threshold elevation point H positioned intermediate the high flow inlet 22 which is above an inlet end 36 at the manhole and above the discharge end 34, which may or may not be above the pond normal water level NWL.

Embodiments are contemplated wherein both the high and low flow inlets 22,20 are pipes P, open channels C or some combination thereof as deemed appropriate by one skilled in the art. By way of example, where the inflow W is conveyed by a combination of channel C and pipe P, the inflow W may be carried by a pipe P exiting the manhole 13, the pipe P delivering the inflow W therefrom to the open channel C which discharges to the stormpond 10. Alternatively, the manhole may discharge to an open channel C which is directed to a pipe P discharging into the stormpond 10.

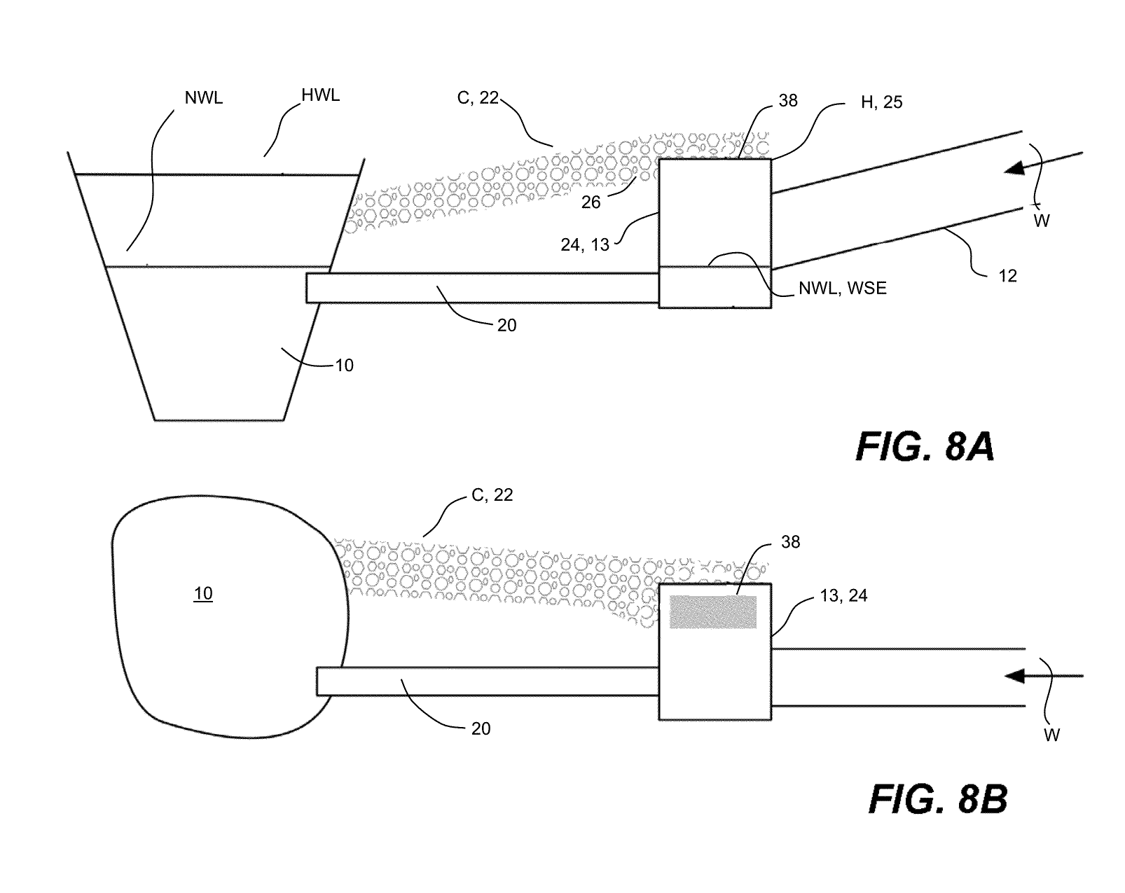

In an embodiment shown in FIGS. 8A and 8B, the spill control element 25 and threshold H are established simply by enabling the inflow W to exit from an outlet 38 in or adjacent a top 38 of the manhole 13, such as to an open channel C. Thus, the outlet 38 acts as the spill control element 25 and establishes the threshold H. More generally, embodiments may also involve inflow W exiting the manhole 13 from from the bottom or from any combination of exits from the top, bottom or sides of a manhole through channels C, pipes P or combinations thereof as may be deemed appropriate by one of skill in the art.

Prior art stormponds, constructed according to FIGS. 1A and 1B, can be retrofit according to the concepts disclosed herein. A weir wall 25 can be constructed within the existing manhole 13 for splitting the manhole 13 into upstream and downstream sides 28, 30 as taught herein. Downstream from the retrofit manhole 40, the existing drainage inlet 12 is converted to function as the high flow inlet 22. A new, low flow inlet 20 is installed to discharge normal intensity inflows W from the retrofit manhole 40 to a location spaced from the discharge end 34 of the high flow inlet 12,22. Alternatively, a low flow inlet 20 may be constructed inside the high flow inlet 12, 22.

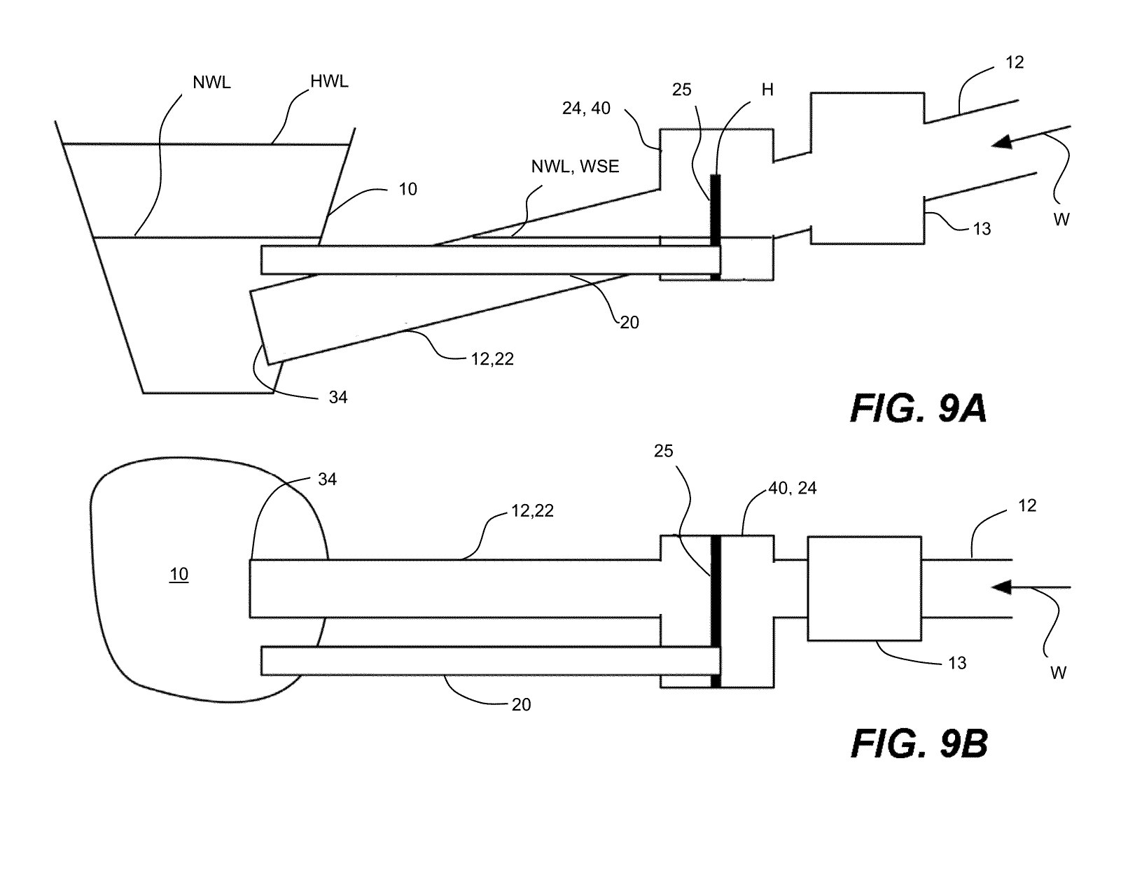

In an embodiment, shown in FIGS. 9A and 9B, a retrofit manhole 40, having a weir wall 25 therein according to embodiments disclosed herein, is constructed offset from the existing manhole 13. Downstream from the retrofit manhole 40, the existing drainage inlet 12 is converted to function as the high flow inlet 22. A new, low flow inlet 20 is installed to discharge normal intensity inflows W from the retrofit manhole 40 to a location spaced from the discharge end 34 of the high flow inlet 12,22.

In a case where retrofit of the stormpond 10, according to the embodiment shown in FIGS. 9A and 9B, is deemed to be impractical, due to some constraint, such as physical constructability, that would not enable construction of the low flow inlet 20 separate from the existing drainage inlet 12, alternate retrofits are possible.

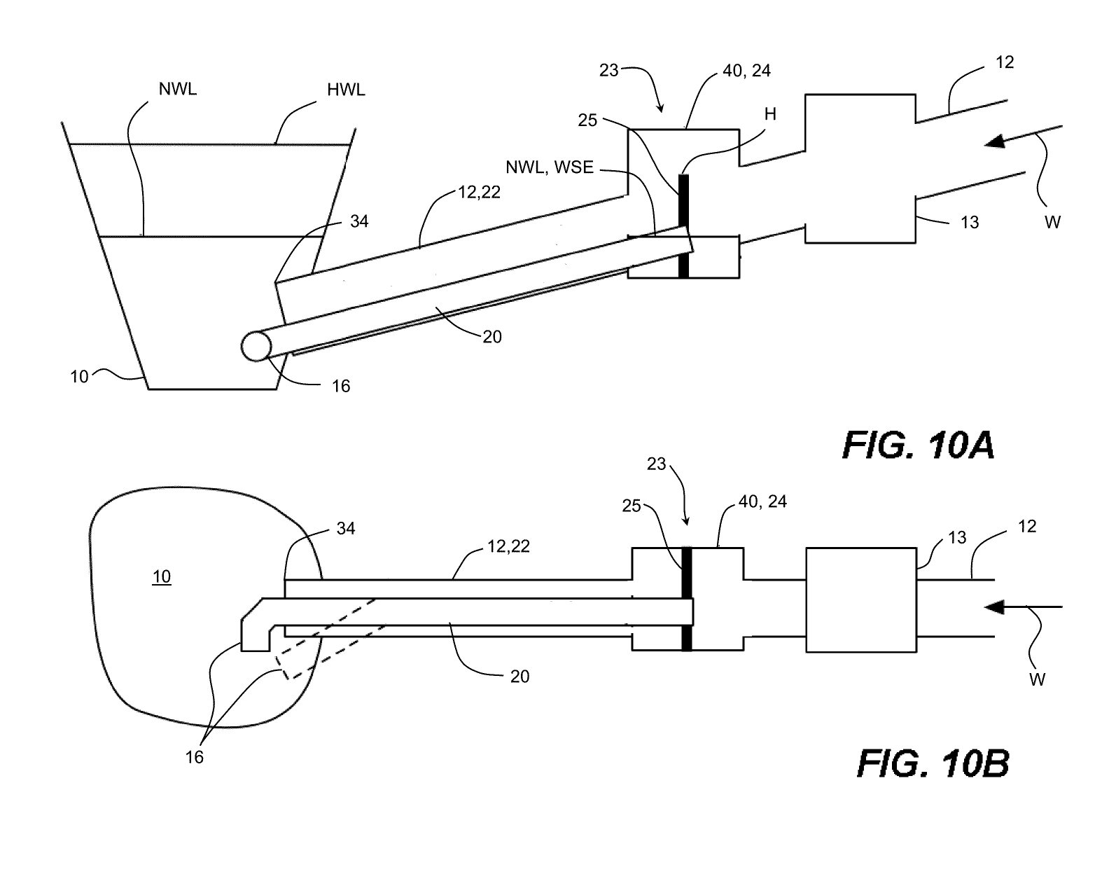

Having reference to FIGS. 10A and 10B, the retrofit manhole 40, having the weir wall 25 according to embodiments disclosed herein, is constructed offset from the existing manhole 13. While discussed herein in the context of a downstream retrofit manhole 40, as illustrated in FIGS. 9A, 9B, 10A and 10B, one of skill will appreciate that an upstream or otherwise offset configuration may better suit a particular environment, without departing from the concepts disclosed herein.

Downstream from the retrofit manhole 40, the existing drainage inlet 12 is converted to function as the high flow inlet 22. A low flow inlet 20, typically a pipe, is housed within the high flow inlet 22 and extends beyond the discharge end 34 thereof. In an embodiment, the discharge end 16 of the low flow inlet 20 is angled or bent so as to direct the inflow W to a location clear of any influence from high flows discharged from the high flow inlet 12,22.

Optionally, as shown in dashed lines on FIG. 10B, the discharge end 16 of the low flow inlet 20 can be diverted away from the discharge end 34 of the high flow inlet 34 for discharge to a more remote location in the pond 10, clear of any influence from high flows discharged from the high flow inlet 12,22.

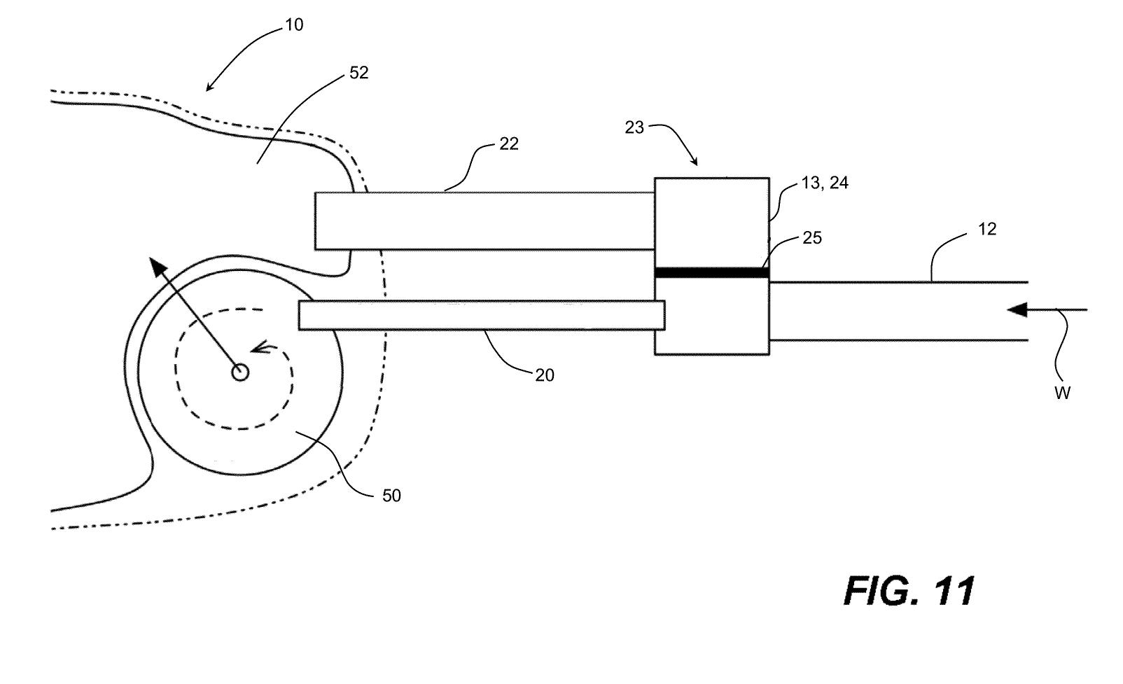

As shown in FIG. 11, embodiments disclosed herein are particularly suited for use in a stormpond 10 having at least two cells wherein a first cell 50 has a particular configuration, known as a NAUTILUS POND®, which is described in detail in Applicant's corresponding U.S. Pat. No. 8,333,895 and Canadian Patent 2,704,715. The NAUTILUS POND®, provides the functionality of a high efficiency sedimentation forebay 32, being particularly well suited to receive inflows W from the low flow inlet 20. The high flow inlet 22 is positioned to discharge in a second cell 52 which is sufficiently spaced from the NAUTILUS POND®, so as not to interfere with the sediment settling function therein.

Embodiments are discussed herein in the context of a single inlet to the stormpond, however as one of skill will appreciate, embodiments disclosed herein can be applied to any number of inlets to the stormpond. While a stormpond typically has one outlet, being a pipe, an open channel, an orifice, a weir and the like, embodiments are possible wherein the pond has more than one outlet.

The embodiments in which an exclusive property or privilege is claimed are defined as follows:

1. A system for directing sediment-containing fluids to a receiving pond comprising:
at least one low flow inlet for fluidly connecting to the pond;
at least one high flow inlet for fluidly connecting to the pond; and
an hydraulic control system for fluidly connecting between the low flow inlet and the high flow inlet for
delivering the sediment-containing inflow through the at least one low flow inlet for delivery to the pond, at a minimum sediment-mobilizing velocity for discharging sediment therefrom, when a rate of flow of fluids maintains a water surface elevation at an upstream side of the hydraulic control element at or below a threshold; and
when the rate of flow of fluids causes the water surface elevation at the hydraulic control element to rise above the threshold,
delivering a balance of the sediment-containing inflow through the at least one high flow inlet for delivery to the pond.

2. The system of claim 1 wherein the low flow inlet and the high flow inlet discharge to different locations in the pond.

3. The system of claim 1 wherein a diameter of the low flow inlet is smaller relative to the diameter of the high flow inlet for maintaining the minimum sediment-mobilizing velocity.

4. The system of claim 1 wherein the hydraulic control system further comprises a fluid directing element positioned upstream of the pond for receiving the inflow and a spill control element having a height for establishing the threshold and for dividing the fluid directing element into
an upstream side, fluidly connected to the low flow inlet for delivering the sediment-containing inflow to the pond when water surface elevation therein is below the threshold; and
a downstream side, fluidly connected to the high flow inlet for receiving and delivering the balance of the sediment-containing inflow therethrough to the pond when the water surface elevation in the low flow inlet exceeds the threshold.

5. The system of claim 4 wherein the fluid directing element is a basin.

6. The system of claim 4 wherein the fluid directing element is a manhole.

7. The system of claim 1 wherein the low flow inlet is one of an open channel, a pipe or a combination thereof and is submerged, partially submerged, unsubmerged or combinations thereof.

8. The system of claim 1 wherein the high flow inlet is one of an open channel, a pipe or a combination thereof and is submerged, partially submerged, unsubmerged or combinations thereof.

9. The system of claim 1 wherein the hydraulic control system further comprises:
a fluid directing element positioned upstream of the pond for receiving the inflow; and
a spill control element having a height for establishing the threshold.

10. The system of claim 9 wherein the fluid directing element is a manhole for receiving the sediment-containing inflow, the manhole being fluidly connected to the low flow inlet; and
wherein the spill control element is an outlet in or adjacent a top of the manhole for establishing the threshold, the outlet being fluidly connected to the high flow inlet.

11. The system of claim 9 wherein the fluid directing element is a manhole for receiving the sediment-containing inflow, the low flow inlet and high flow inlet being fluidly connected between the manhole and the pond; and
wherein the spill control element is a threshold elevation point positioned intermediate the high flow inlet, wherein when a water surface elevation in the high flow inlet exceeds the threshold elevation point, the balance of the sediment-containing inflow spills thereover for delivery therethrough to the pond.

12. The system of claim 1, having an existing manhole for receiving the sediment-containing inflow and an existing drainage inlet for delivery to the manhole and therefrom to the pond, the system further comprising:
a retrofit manhole positioned offset the existing manhole, the retrofit manhole having a weir wall, the weir wall having a height for establishing the threshold and for dividing the retrofit manhole into a upstream side and a downstream side; and
at least one retrofit low flow inlet fluidly connected between the upstream side and the pond for delivering of the sediment-containing inflow therethrough to the pond when the water surface elevation in the retrofit manhole is at or below a threshold;
wherein the existing drainage inlet is fluidly connected to the upstream side of the manhole for delivering the sediment-containing inflow thereto, and
wherein the existing drainage inlet is fluidly connected to the downstream side for delivering the balance of the sediment-containing inflow therethrough to the pond when the rate of flow of fluids causes the water surface elevation at the spill control element to rise above the threshold.

13. The system of claim 1 wherein the low flow inlet is positioned within the high flow inlet.

14. The system of claim 13 further comprising:
an offset, discharge end of the low flow inlet for delivering the sediment-containing inflow therefrom to a different location in the pond than the high flow inlet.

15. A method for directing sediment-containing fluids to a receiving pond comprising:
fluidly connecting at least one low flow inlet to the pond;
fluidly connecting at least one high flow inlet to the pond;
fluidly connecting an hydraulic control system between the low flow inlet and the high flow inlet;
delivering the sediment-containing inflow through the at least one low flow inlet for delivery to the pond, at a minimum sediment-mobilizing velocity, when a rate of flow of fluids maintains a water surface elevation at an upstream side of the hydraulic control system at or below a threshold; and
delivering a balance of the sediment-containing inflow through the at least one high flow inlet for delivery to the pond when the rate of flow of fluids causes the water surface elevation at the hydraulic control system to rise above the threshold.

16. The method of claim 15 further comprising:
discharging from the low flow inlet and the high flow inlet to different locations in the pond.

17. The method of claim 15, wherein the hydraulic control system further comprises a flow directing element upstream of the pond for receiving the inflow and a spill control element having a height for establishing the threshold, the method comprising:
positioning the spill control element in the flow directing element for forming
the upstream side, fluidly connected to the low flow inlet for delivering the sediment-containing inflow to the pond when water surface elevation therein is below the threshold; and
a downstream side, fluidly connected to the high flow inlet for receiving and delivering the balance of the sediment-containing inflow therethrough to the pond when the water surface elevation in the low flow inlet exceeds the threshold.

18. The method of claim 15 wherein the hydraulic control system further comprises a flow directing element upstream of the pond for receiving the inflow and a spill control element having a height for establishing the threshold, the method comprising:
positioning the spill control element intermediate the high flow inlet.

19. A method for retrofitting an existing system for directing sediment-containing fluids to a receiving pond having an existing manhole and an existing drainage inlet fluidly connected thereto, the method comprising:
positioning a weir wall in the existing manhole therein for dividing the retrofit manhole into an upstream side and a downstream side and having a height for establishing a threshold;
fluidly connecting the existing drainage inlet to the upstream side for delivery of sediment-containing inflow thereto;
fluidly connecting a low flow inlet to the upstream side for delivery to the pond at a minimum sediment-mobilizing velocity, when a rate of flow of fluids maintains a water surface elevation in the upstream side of the retrofit manhole at or below the threshold; and
fluidly connecting the existing drainage inlet to the downstream side for delivering a balance of the sediment-containing inflow through the at least one high flow inlet for delivery to the pond when the rate of flow of fluids causes the water surface elevation at the hydraulic control element to rise above the threshold.

20. The method of claim 19 further comprising:
discharging from the low flow inlet and the high flow inlet to different locations in the pond.

21. The method of claim 19 further comprising:
positioning the low flow inlet within the high low inlet.

22. The method of claim 21 further comprising:
offsetting a discharge end of the low flow inlet for delivering the sediment-containing inflow therefrom to the different location in the pond than the high flow inlet.

23. A method for retrofitting an existing system for directing sediment-containing fluids to a receiving pond having an existing manhole and an existing drainage inlet fluidly connected thereto, the method comprising:
positioning a retrofit manhole offset from the existing manhole, the retrofit manhole having a weir wall therein for dividing the retrofit manhole into an upstream side and a downstream side and having a height for establishing a threshold;
fluidly connecting the existing drainage inlet to the upstream side for delivery of sediment-containing inflow thereto;
fluidly connecting a low flow inlet to the upstream side for delivery to the pond, at a minimum sediment-mobilizing velocity, when a rate of flow of fluids maintains a water surface elevation in the upstream side of the retrofit manhole at or below the threshold; and
fluidly connecting the existing drainage inlet to the downstream side for delivering a balance of the sediment-containing inflow through the at least one high flow inlet for delivery to the pond when the rate of flow of fluids causes the water surface elevation at the hydraulic control element to rise above the threshold.

24. The method of claim 23 further comprising:
discharging from the low flow inlet and the high flow inlet to different locations in the pond.

25. The method of claim 23 further comprising:
positioning the low flow inlet within the high flow inlet.

26. The method of claim 25 further comprising:
offsetting a discharge end of the low flow inlet for delivering the sediment-containing inflow therefrom to a different location in the pond than the high flow inlet.
